(19) United States
(12) Patent Application Publication
(10) Pub. No.: US 2008/0318094 A1
(43) Pub. Date: Dec. 25, 2008

(54) METHODS FOR CONVERSION OF A LIGHT ALKANE TO A HIGHER HYDROCARBON, METHOD OF DEHYDROGENATING AN ALKANE, AND METHOD OF REACTIVATING A CATALYST LAYER

(76) Inventors: Daniel M. Ginosar, Idaho Falls, ID (US); James R. Fincke, Los Alamos, NM (US); Robert S. Cherry, Idaho Falls, ID (US)

Correspondence Address: Stephen R. Christian, Bechtel BWXT Idaho, LLC, P.O.Box 1625, Idaho Falls, ID, 83415-3899, US

(21) Appl. No.: 12/106,409

(22) Filed: Apr. 21, 2008

Related U.S. Application Data
(62) Division of application No. 10/269,649, filed on Oct. 9, 2002, now abandoned.

(51) Int. Cl. H01M 8/04

(52) U.S. Cl. 429/17

(57) ABSTRACT

A controllable proton exchange reactive membrane comprising a proton exchange membrane, at least two catalyst layers disposed on opposing sides of the proton exchange membrane, and a power source operably coupled to the at least two catalyst layers. A direction and magnitude of flow of hydrogen through the proton exchange reactive membrane is controlled by modulating the power source across the proton exchange membrane, thereby enabling hydrogen to be transported in either direction across the proton exchange reactive membrane. By controlling the transport of hydrogen, the extent of a homologation reaction is enhanced. A proton exchange reactive membrane reactor comprising the proton exchange reactive membrane is also disclosed. A method of producing a higher hydrocarbon from a light alkane is disclosed, as is a method of regenerating a catalyst layer.

### CROSS-REFERENCE TO RELATED APPLICATION

This application is a divisional of application Ser. No. 10/269,649, filed Oct. 9, 2002, pending. The disclosure of the previously referenced U.S. patent application is hereby incorporated by reference in its entirety.

### GOVERNMENT RIGHTS

The United States Government has certain rights in this invention pursuant to Contract No. DE-AC07-991D13727, and Contract No. DE-AC07-051D14517 between the United States Department of Energy and Battelle Energy Alliance, LLC.

### BACKGROUND OF THE INVENTION

1. Field of the Invention

The present invention relates generally to a proton exchange reactive membrane for use in enhancing the extent of a chemical reaction. More specifically, present invention relates to the use of a proton exchange reactive membrane to enhance the extent of a homologation reaction for conversion of light alkanes to higher hydrocarbons.

2. State of the Art

Modern refinery processes produce significant quantities of light alkane byproducts that have limited potential for blending in liquid transportation fuels. To dispose of these light alkane byproducts, which contain low levels of sulfur, the byproducts are typically flared or burned as a low-value fuel gas to provide heat. However, these disposal techniques represent a large economic loss to refineries. Light alkanes also exist in the form of large reserves of natural gas in remote locations within the United States and the world. While these reserves are abundant, no economical uses for the reserves currently exist. Therefore, these reserves are either never produced or they are reinjected or flared.

One potential use of these light alkanes is to directly convert them into liquid fuels. In a nonoxidative reaction, a light alkane is dehydrogenated using a metal catalyst to produce an alkene. The alkene is then oligomerized or alkylated to produce a higher hydrocarbon, such as liquid fuel. This reaction is referred to herein as a homologation reaction or “upgrading” the alkane to a higher hydrocarbon. While this reaction has the potential for creating liquid fuels from light alkane byproducts, the direct conversion is not thermodynamically favored. When this reaction is run isothermally, the reaction has a positive Gibbs free energy of reaction, which limits the conversion and yield of the resulting liquid fuel.

The extent of the reaction may, however, be improved if the reaction is performed in two steps, as discussed in Amariglio et al., Fuel Proc. Technol. 42 (1995) 291-323; Simon et al., Catal. Today 46 (1998) 217-222; Pareja et al., Ind. Eng. Chem. Res. 38 (1999) 1163-1165; and Amariglio et al., Catal. Today 25 (1995) 113-125. Referring to FIGS. 1A through 1C of the drawings, in the first step (the alkane conversion step), a light alkane 100 is flowed over a surface of a metal catalyst 110. As illustrated in FIG. 1A, the light alkane 100 chemisorbs onto the surface of the metal catalyst 110 and forms hydrogen 150 and a dehydrogenated, activated carbon species 120. The formation of hydrogen 150 during the alkane conversion step limits the equilibrium of the alkane conversion because, as hydrogen 150 accumulates, the dehydrogenation reaction no longer proceeds. As shown in FIG. 1B, the activated carbon species 120 then oligomerizes to form a dehydrogenated, higher hydrocarbon 130. As illustrated in FIG. 1C, in the second step of the homologation reaction (the rehydrogenation step), hydrogen 160 is flowed over the surface of the metal catalyst 110. The hydrogen 160 is provided from a separate source, typically external to the reaction chamber. In addition, the temperature may be adjusted. The dehydrogenated, higher hydrocarbon 130 is rehydrogenated to form the higher hydrocarbon 140, which is released from the surface of the metal catalyst 110. The reaction as described is problematic because if the dehydrogenated, higher hydrocarbon 130 is not rehydrogenated, it adheres to the surface of the metal catalyst 110 and potentially deactivates the metal catalyst 110.

To improve the extent of the overall reaction, the two steps of the foregoing reaction are often conducted at different temperatures. The alkane conversion step is thermodynamically favored at higher temperatures while the rehydrogenation step is thermodynamically favored at lower temperatures. The reaction conditions, such as the temperatures and pressures, are typically moderate, with temperatures under 350° C. and pressures ranging from atmospheric pressure to 250 psi. While using the two temperatures improves the extent of the reaction, the reaction is still equilibrium-limited unless the two steps are separated by first flowing the hydrocarbon and then flowing the hydrogen.

To enhance the reaction kinetics, a catalyst is used. In Simon et al., a Ni—Cu metal catalyst supported on silicon dioxide (SiO₂) is disclosed. The Ni—Cu metal catalyst is used to produce hydrocarbons having up to nine carbons from a methane feedstream. While the rate of this reaction is improved, the dehydrogenation of the alkane is still equilibrium-limited by the presence of excess hydrogen. In addition, deactivation of the Ni—Cu catalyst is rapid and multiple reaction, separation, and processing steps are required to produce the desired hydrocarbon. Furthermore, the resulting yields and the conversion efficiency of the hydrocarbon are low.

Proton exchange membranes (“PEMs”) are known in the art to separate, transport, or supply hydrogen. PEMs are commonly used in fuel cells to generate power from the hydrogen. As illustrated in FIG. 2, the PEM 200 transports hydrogen 210 as protons by passing an electrical current 240 through an external circuit 260, which connects the two sides of the PEM 200. Hydrogen 210 is introduced at a first electrode (anode) 230 where it reacts electrochemically in the presence of a catalyst to produce electrons 240 and protons (“H⁺”) 250. The electrons 240 are circulated from the first electrode 230 to a second electrode (cathode) 230′ through an electrical circuit 260, which is connected to a power source or a power consuming device. The protons 250 pass through a proton-conducting, solid electrolyte to the second electrode 230′. After passing through the PEM 200, the protons 250 are recombined with electrons 240 to form hydrogen 210, which is then discharged.

The extent of the homologation reaction has been enhanced using a hydrogen transport membrane. In Garnier et al., Ind. Eng. Chem. Res. 36 (1997) 553-558, the use of a Pd—Ag membrane reactor to produce hydrogen and higher hydrocarbons is disclosed. The Pd—Ag membrane reactor uses a Pd—Ag membrane to enhance the dehydrogenation of the light alkane. While the extent of the dehydrogenation step is improved, the Pd—Ag membrane does not enhance the extent of the rehydrogenation step because the Pd—Ag membrane continually removes the hydrogen that is needed to produce the higher hydrocarbon. Therefore, the Pd—Ag membrane actually reduces the efficiency of the rehydrogenation step.

While processes for converting light alkanes to higher hydrocarbons exist, these processes are not optimal because the thermodynamics limit the extent of the reaction. These processes are also complicated because they require significant swings in operating conditions. Furthermore, many of the processes are expensive and require multiple steps. For instance, dehydrogenation processes, such as British Petroleum's CYCLAR™ process, which converts propane to benzene, operate at low pressures and require substantial recycle to deal with the unfavorable equilibrium. Another known process isomerizes n-butane to iso-butane, dehydrogenates the iso-butane to form iso-butylene, and then reacts the iso-butylene with methanol to form methyl tertiary butyl ether (“MTBE”). However, since the use of MTBE in gasoline is being eliminated, process licensors are proposing to dimerize the iso-butylene to iso-octene and then hydrogenate the iso-octene to produce iso-octane. These two processes are proposed to be combined to form a homologation route for n-butane to iso-octane, but this process is projected to be expensive.

It would be desirable to further adjust the equilibrium of the homologation reaction to improve the conversion efficiency of a light alkane and the yield of higher hydrocarbon. A less expensive homologation reaction that requires less intensive operating conditions and fewer steps would also be attractive.

### BRIEF SUMMARY OF THE INVENTION

The present invention includes a controllable proton exchange reactive membrane (“PERM”) comprising a proton exchange membrane (“PEM”) disposed between at least two catalyst layers and a power source. The power source, which may be a current source or a voltage source, is operably coupled to the at least two catalyst layers flanking the PEM so that a direction and magnitude of flow of hydrogen across the PERM may be controlled by modulating an output of the power source. A magnitude of flow of hydrogen across the PERM may be controlled, for example, by amplitudinally modulating the voltage. The hydrogen may be transported in either direction across the PERM by, for example, reversing the current flow. By controlling the flow of hydrogen, the extent of a homologation reaction may be enhanced. At least one of the at least two catalyst layers is disposed on each side of the PEM and operably coupled to the power source. Additional catalyst layers, if desired or required, may be disposed on each side of the PEM.

The present invention also includes a PERM comprising a PEM, at least one catalyst layer, and a power source is also disclosed. By balancing a rate of dehydrogenation of the light alkane with a rate of rehydrogenation of the dehydrogenated, higher hydrocarbon, both the alkane conversion step and the rehydrogenation step are performed on one side of the PEM.

The present invention also includes a PERM reactor. The PERM reactor is configured to produce higher hydrocarbons from light alkanes without requiring a source of hydrogen external to the PERM reactor. The PERM reactor comprises a controllable PERM having a PEM disposed between at least two catalyst layers and a power source operably coupled to the at least two catalyst layers. Hydrogen may be transported in either direction across the controllable PERM by directionally modulating the voltage bias on the power source and the magnitude of hydrogen flow may be controlled by varying the voltage amplitude.

The present invention also includes a method of producing a higher hydrocarbon from a light alkane. The method comprises contacting the PERM with a light alkane to form an activated carbon species and hydrogen on a reaction side of the PERM. The hydrogen is transported from the reaction side of the PERM to a hydrogen-rich side by directionally modulating the voltage bias on the power source and amplitudinally modulating the voltage. The activated carbon species is oligomerized and rehydrogenated to form a higher hydrocarbon by flowing hydrogen from the hydrogen-rich side of the PERM to the reaction side by reversing the direction of the current from the power source and controlling a magnitude of hydrogen flow by varying the amplitude of the voltage.

### BRIEF DESCRIPTION OF THE SEVERAL VIEWS OF THE DRAWINGS

In the drawings, which illustrate what is currently considered to be the best mode for practicing the invention:

FIG. 1A-C shows the homologation reaction of a light alkane to a higher hydrocarbon using the two-step method of the prior art;

FIG. 2 illustrates a conventional proton exchange membrane;

FIG. 3A-C illustrates an embodiment of the proton exchange reactive membrane and shows a reaction of a light alkane to form a higher hydrocarbon using the proton exchange reactive membrane;

FIG. 4 illustrates another embodiment of the proton exchange reactive membrane;

FIG. 5 illustrates yet another embodiment of the proton exchange reactive membrane; and

FIG. 6 shows a schematic illustration of a proton exchange reactive membrane reactor.

### DETAILED DESCRIPTION OF THE INVENTION

A controllable PERM 300 is disclosed. In one embodiment, the PERM uses a PEM 200 disposed between at least two catalyst layers 340, and a power source 330 operably coupled to one of the at least two catalyst layers 340 on each side of the PEM 200. The PEM 200, the at least two catalyst layers 340, and the power source 330 are integrated so that a direction and magnitude of flow of hydrogen across the PERM may be controlled by modulation of the output of power source 330. The hydrogen may be transported in either direction across the PERM by, for example, reversing direction of the current, or by otherwise manipulating current flow or cyclicality. A magnitude of hydrogen flow may be altered, for example, by varying the amplitude of the applied voltage. By controlling the flow of hydrogen, the extent of a homologation reaction may be enhanced.

The controllable PERM 300 allows the catalytic homologation of light alkanes to produce higher hydrocarbons by utilizing the equilibrium-shifting potential of a catalytic membrane. The controllable PERM thus provides a method of producing clean liquid transportation fuels using the non-oxidative homologation of light alkanes to higher hydrocarbons. In addition, the conversion efficiency and product yields of the reaction are significantly improved and the reaction process is simplified.

The PEM 200 may be formed from a solid, proton-conductive material known in the art, such as a ceramic or a polymer. The ceramic material may be a metal oxide such as an oxide of Ru or Ru—Ti, an acid oxide of a heavy post-transition element such as antimony or tin, or an oxide of a heavy early transition metal such as Mo, W, or Zr. The ceramic material may also be a perovskite-type oxide. The PEM may also be a polymeric material. The polymer may be perfluorinated sulfonic acid or a derivative thereof, such as NAFION™, which is available from E.I. du Pont de Nemours and Company (Wilmington, Del.). The material used in the PEM 200 may be selected depending on the temperature at which the homologation reaction is conducted. For instance, a polymeric material may be used as the PEM 200 at operating temperatures below approximately 150° C. At operating temperatures greater than approximately 150° C., the PEM 200 may be formed from a ceramic material. The thickness of the PEM 200 may be minimized since the transport rate of hydrogen through the PEM 200 is inversely related to its thickness. However, the PEM 200 may be of sufficient thickness to maintain its integrity and to prevent holes or cracks from forming in the PEM 200.

The PEM 200 may be flanked on each side by one of the at least two catalyst layers 340, as shown in FIG. 3A. At least one of the catalyst layers 340 on each side of the PEM 200 may be electrically conductive so that current or voltage from the power source 330 is available across the entire surface of the PERM 300. However, it is also contemplated that an electrically conductive, but noncatalytic, layer may be formed adjacent to the catalyst layers 340 to conduct current or voltage from the power source 330. Each of the catalyst layers 340 is formed of a catalyst material comprising a metal catalyst. Since the outer surface of each catalyst layer 340 is exposed to different conditions, each of the catalyst layers 340 may be formed from a different catalytic material. For instance, the catalyst layer 340 on a reaction side 310 of the PERM 300 may be exposed to reactants and products of the homologation reaction. Therefore, the catalyst layer 340 on the reaction side 310 may be formed from a material known to catalyze the dehydrogenation of the light alkane. The catalyst layer 340 on the reaction side 310 may also form protons 250 and electrons 240 from hydrogen 150. The catalyst layer 340 on a hydrogen-rich side 320 of the PERM 300 is exposed to hydrogen and, therefore, may be compatible with hydrogen. In addition, the catalyst layer 340 may catalyze the reaction of protons 250 and electrons 240 to form hydrogen 150. The composition of the catalyst layers 340 may be adjusted depending on the reaction performed and the conditions under which the reaction is performed. The catalyst layers 340 may be formed from conventional materials, such as Co, Pt, Ni, Ni—Cu, Ru, Cu, Ag, Pd, Pd—Ag, Pd—Yb, Rh, alloys thereof, or mixtures thereof. For example, the catalyst layer 340 on the reaction side 310 may be a Ni—Cu catalyst supported on silicon dioxide and the catalyst layer 340 on the hydrogen-rich side 320 may be Pt, Ru, Rh, Co, Ni, Cu, Ag, Pd, Pd—Ag, or Pd—Yb.

In addition to the embodiment of the PERM 300 illustrated in FIG. 3A, multiple catalyst layers 340 may be disposed on one or both sides of the PEM 200. Two or more catalyst layers 340 may be formed on each side of the PEM 200 with a first catalyst layer 340 catalyzing the formation of hydrogen 150 from protons 250 and electrons 240 or the decomposition of hydrogen 150 into protons 250 and electrons 240. A second catalyst layer 340 catalyzes the homologation reaction. By using two or more catalyst layers 340 on each side of the PEM 200, the efficiency of the PEM 200 may be increased because the homologation reaction and the formation of hydrogen 150 or protons 250 and electrons 240 may be conducted on each side of the PEM 200. For instance, if two catalyst layers 340 are formed on each side of the PEM 200, the efficiency may be doubled. In this situation, the homologation reaction may occur on a first side of the PEM 200 (such as the reaction side 310) while the formation or decomposition of hydrogen 150 occurs on a second side of the PEM 200 (such as the hydrogen-rich side 320). However, by reversing the direction of the current, the reaction catalyzed on each side of the PEM 200 may be reversed so that the formation of hydrogen 150 occurs on the first side of the PEM 200 and the homologation reaction occurs on the second side. As illustrated in FIG. 4, two catalyst layers 340A and 340B are formed on the reaction side 310 of the PEM 200 and two catalyst layers 340B and 340C are formed on the hydrogen-rich side 320. In FIG. 4, only the PERM 300, the PEM 200, the conductive traces 270, the power source 330, and the catalyst layers 340A-C are shown for clarity. The first catalyst layer 340A on the reaction side 310 may be formed from a catalytic material that catalyzes the decomposition of hydrogen 150 into protons 250 and electrons 240. The second catalyst layer 340B may be formed from a catalytic material that catalyzes the homologation reaction. The first catalyst layer 340C on the hydrogen-rich side 320 of the PEM 200 may be formed from a catalytic material that catalyzes the formation of hydrogen 150 from protons 250 and electrons 240 while the second catalyst layer 340B catalyzes the homologation reaction. The second catalyst layer 340B on each side of the PEM 200 may be formed from the same or a different catalytic material. If multiple catalyst layers 340 are used on each side of the PEM 200, the catalyst layers 340 that catalyze the formation or decomposition of hydrogen 150 may be electrically conductive so that current or voltage from the power source 330 is available across the entire surface of the PERM 300. In other words, the catalyst layers 340 that catalyze the formation or decomposition of hydrogen 150 may be electrically connected to the power source 330 through conductive traces 270. However, the catalyst layers 340 that catalyze the homologation reaction may not be required to be electrically connected to the power source 330.

It is also contemplated that a single catalyst layer 340 may be disposed on each side of the PEM 200. The catalyst layer 340 may include a catalytic material that catalyzes the homologation reaction and either the reaction to form hydrogen 150 or the reaction to decompose hydrogen 150. In other words, the catalyst layer 340 may be formed from a catalytic material that has dual catalytic activities and is capable of both catalyzing the homologation reaction and catalyzing either the reaction to form hydrogen 150 or the reaction to decompose hydrogen 150. For example, one catalyst layer 340 on the reaction side 310 of the PEM 200 may catalyze the homologation reaction and the formation of protons 250 and electrons 240 from hydrogen 150. The catalyst layer 340 on the hydrogen-rich side 320 may catalyze the homologation reaction and the formation of hydrogen 150. If a single catalyst layer 340 having dual catalytic activity is disposed on each side of the PEM 200, each of these catalyst layers 340 may be electrically connected to the power source 330.

The catalyst layer 340 may also be formed from a mixture of at least two catalytic materials, where at least one of the catalytic materials catalyzes the homologation reaction and the other catalytic material catalyzes the reaction to form hydrogen 150 or the reaction to form protons 250 and electrons 240. For example, a mixture of catalytic materials may be co-deposited to form the catalyst layer 340, such as by simultaneously sputtering or co-precipitating the different catalytic materials.

The power source 330 used in the PERM 300 may be a current source or a voltage source and may provide a fixed voltage or current, the other variable (current or voltage) floating to a value which depends on the impedance of the circuit. For example, the power source 330 may be a bidirectional current source, such as an alternating current source, connected by conductive traces 270 to the at least two catalytic layers 340. The current or voltage provided by the power source 330 may be conducted between the catalyst layer 340 that forms hydrogen 150 and the catalyst layer 340 that decomposes hydrogen 150. The power source 330 may provide a desired voltage and current to the PERM 300. By modulating its output, the power source 330 may be used to control the direction of hydrogen movement across the PERM 300. Modulation of the power source output may be effected as known in the art, such as by changing polarity of the current or by including a period of no current between half-cycles of the current. Directional modulation may also be effected by a shaping of the current versus time within each half-cycle to achieve a desired series of chemical conditions on the catalyst layer 340 within each half-cycle. In this situation, the two half-cycles may or may not be identical. Over time, the half-cycles may be altered to account for variables such as catalyst aging, feedstock changes, reactor temperature perturbations, or a changed operating rate. Thus, it will be appreciated by those of ordinary skill in the art that various manners of modulation of the output of the power source may be employed to control either or both of the direction and magnitude of hydrogen movement across the PERM 300, and the term “modulation” with respect to the output of power source 330 encompasses any variation, as relevant, in magnitude, polarity, cyclicality, shape, or timing of voltage and current components, separately or in combination, of the power source output.

In another embodiment, the PERM 300 may comprise a PEM 200, one catalyst layer 340 to catalyze the homologation reaction, and a power source 330 operably coupled to the catalyst layer 340, as illustrated in FIG. 5. Only these elements are shown in FIG. 5 for clarity. The PEM 200, the catalyst layer 340, and the power source 330 are integrated so that the flow of hydrogen across the PERM 300 is controlled by modulating the output of power source 330. By adjusting the catalytic activity of the catalyst layer 340 and the concentration of reactants, the rate of dehydrogenation of the light alkane (in the alkane conversion step) may be substantially similar to the rate of rehydrogenation of the dehydrogenated, higher hydrocarbon 130 (in the rehydrogenation step). By balancing these two reaction rates, the PERM 300 may transport an amount of hydrogen 150 through the PEM 200 to remove excess hydrogen 150 that is not required in the rehydrogenation step. Since both steps of the homologation reaction may occur on one side of the PEM 200, only that side of the PEM 200 requires a catalyst layer 340 capable of catalyzing the homologation reaction. However, it is understood that a catalyst layer 340 may still be necessary on the hydrogen-rich side 320 to combine the protons 250 and electrons 240 to form hydrogen 150. In this embodiment, a cyclic power source 330 may not be necessary. Rather, the power source 330 may be run with one polarity. However, the current or voltage may be varied to account for changing reactor conditions.

Since the PERM 300 is controllable, the flow of hydrogen 150 across the PERM 300 may be activated or inactivated as desired. As shown in FIG. 3A, when an excess of hydrogen 150 is present on the reaction side 310 of the PERM 300, the hydrogen 150 may be moved across the PERM to the hydrogen-rich side 320 by activating the power source 330 to cause current to flow in a first direction as shown, where the amplitude of the voltage is used to control the magnitude of hydrogen flow. As shown in FIG. 3C, if an excess of hydrogen 150′ is present on the hydrogen-rich side 320 of the PERM 300 or if additional hydrogen 150′ is needed on the reaction side 310 of the PERM 300, the hydrogen 150′ may be transported to the reaction side 310 of the PERM 300 by activating the power source 330 to cause current to flow in a second, opposing direction as shown. When the flow of hydrogen 150 is no longer necessary, the movement of hydrogen 150 in either direction may be stopped by inactivating the power source 330, as shown in FIG. 3B. The activated carbon species 120 reacts to rehydrogenate with either recycled (from the hydrogen-rich side) hydrogen, hydrogen supplied by the continuous decomposition of the light alkane, hydrogen supplied in the alkane feed, or a combination thereof. It is contemplated that the reaction kinetics may be enhanced to provide a continuous, steady-state conversion process.

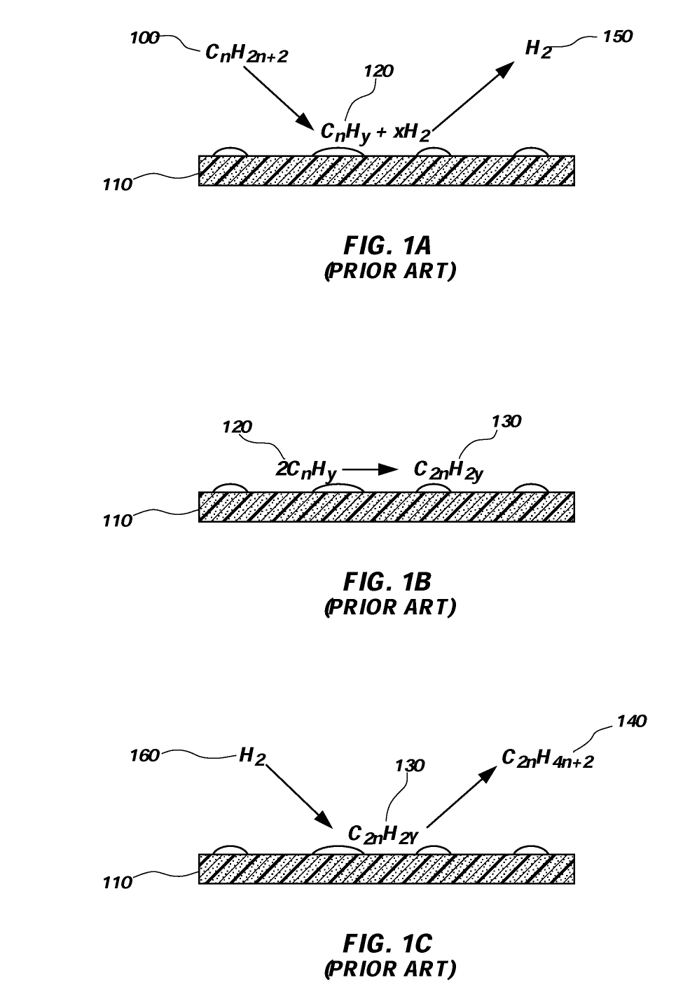

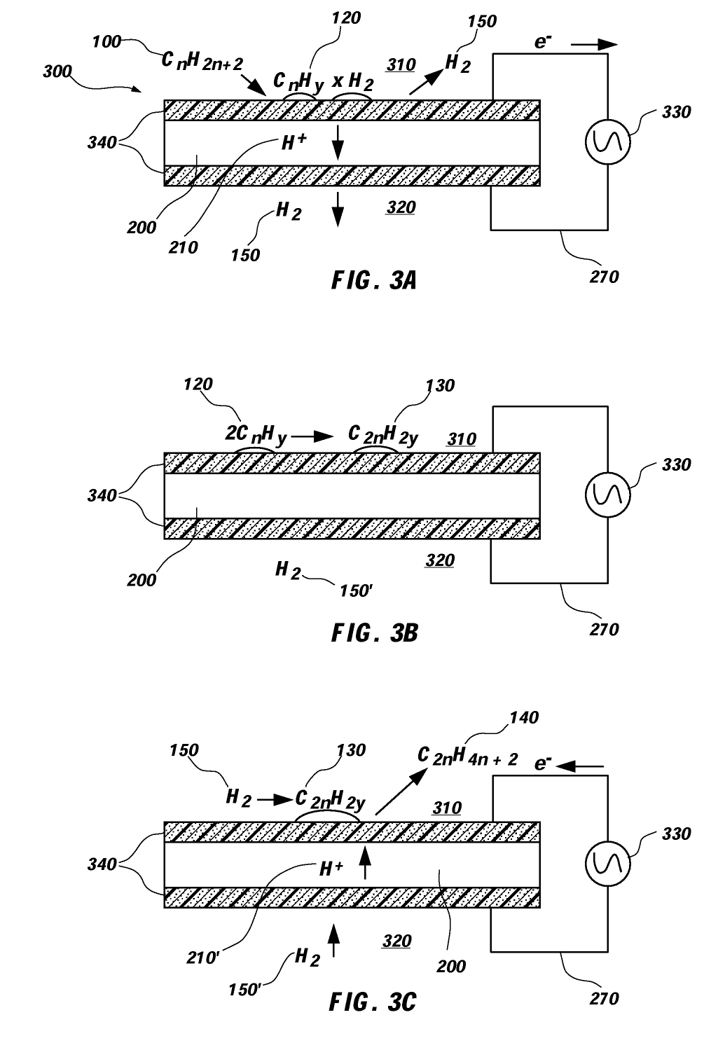

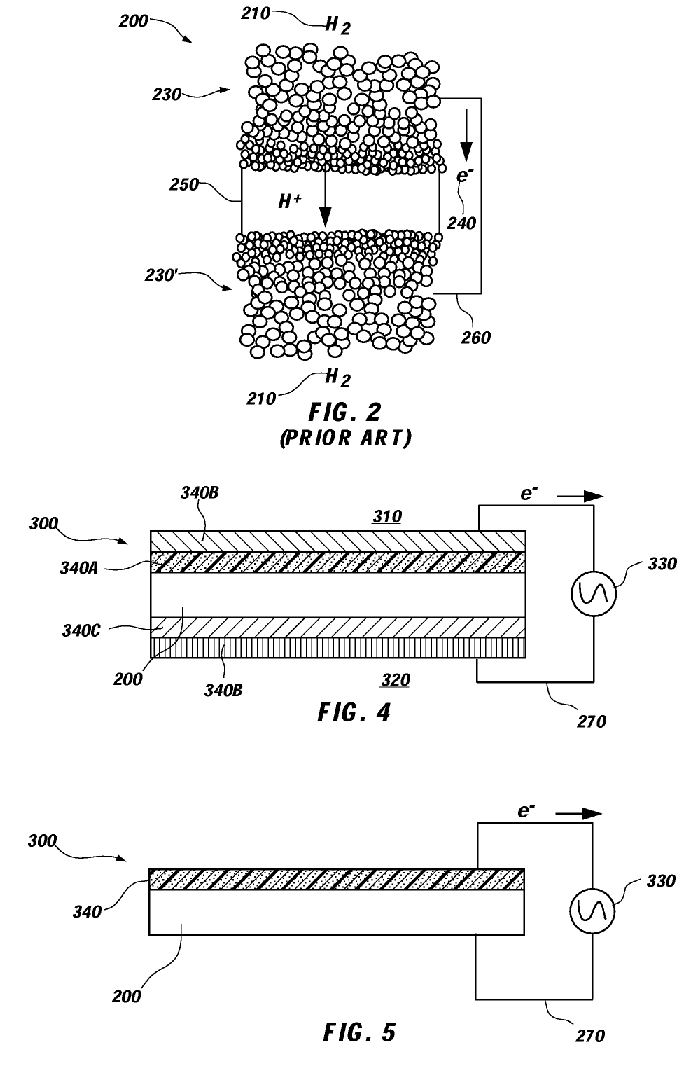

Hydrogen 150 may flow in either direction across the PERM 300 depending on the direction of flow of current. Hydrogen 150 may be caused to flow from the reaction side 310 to the hydrogen-rich side 320 or in the reverse direction, from the hydrogen-rich side 320 to the reaction side 310 by modulating the output of power source 330. Since the hydrogen 150 may be caused to flow in either direction, a separate source of hydrogen, such as hydrogen 160 in FIG. 1C, is no longer needed to support the second step of the homologation reaction (rehydrogenation). To illustrate that the hydrogen 150 on both sides of the PERM 300 is from the same source, the hydrogen present on the hydrogen-rich side 320 of the PERM 300 is labeled as 150′ while the hydrogen present on the reaction side 310 is labeled as 150. The flow of hydrogen 150 across the PERM may be used to change the equilibrium of the homologation reaction by selectively removing, or “pumping,” hydrogen away from the reaction side 310. By removing this hydrogen 150, the equilibrium of the reaction is enhanced.

The PERM 300 may be produced by techniques known in the art and, therefore, the production of the PERM 300 is not discussed in detail herein. For instance, the PEM 200, the catalyst layers 340, and power source 330 may be produced using conventional techniques or such elements and components may be purchased commercially.

To transport the hydrogen 150 from one side of the PERM 300 to the other side, a partial pressure gradient or a voltage gradient may be used. If a concentration gradient is present, the hydrogen 150 travels from a high concentration side of the PERM 300 to a low concentration side. To transport the hydrogen 150 from the low concentration side to the high concentration side, a higher pressure may be used on the low concentration side than on the high concentration side. Such a pressure gradient may be generated by running the homologation reaction at a higher pressure on one side of the PERM 300, such as the reaction side 310. A voltage gradient may also be used to transport the hydrogen 150 from the low concentration side to the high concentration side. With the voltage gradient, a voltage potential may be used to force the current from the low concentration side to the high concentration side.

When a concentration gradient exists across the PEM 200, the flux of hydrogen is indicated by the following equation:

$${J}_{{H}_{2}} ∝ \frac{1}{t} ln ( \frac{{P}_{1}}{{P}_{2}} )$$

where t is the thickness of the membrane, P₁ is the partial pressure of hydrogen on the reaction side of the PERM 300, and P₂ is the partial pressure of hydrogen on the hydrogen-rich side. The corresponding current in the external circuit is

I=2J_{H2}F

where F is Faraday's constant and the unit area is assumed. The flux of hydrogen 150 across the PEM 200 may be inhibited by imposing a reverse bias voltage. When the current is imposed, protons 250 may be pumped across the PEM 200 against an unfavorable concentration gradient. The hydrogen flux is related to the current by the following equation:

J_{H2}=I/2F

In addition to being able to direct the flow of hydrogen 150 in either direction, the controllable PERM 300 may be used to clean or reactivate the catalyst layer 340 on the reaction side 310 of the PERM 300. Over time, this catalyst layer 340 may become deactivated by dehydrogenated higher hydrocarbons 130 or higher hydrocarbons 140 that build up on its surface. For instance, these dehydrogenated higher hydrocarbons 130 may not be rehydrogenated during the second step of the reaction and, therefore, remain adhered to the surface of the catalyst layer 340. In addition, the higher hydrocarbons 140 may not desorb from the surface of the catalyst 110 and, therefore, also contribute to the deactivation of the catalyst layer 340. The dehydrogenated higher hydrocarbons 130 and higher hydrocarbons 140 that are deposited on the surface of the catalyst 110 may be removed by flowing the hydrogen 150′ from the hydrogen-rich side 320 of the PERM 300 to the reaction side 310. The hydrogen 150′ may be flowed in this direction by modulating the output of power source 330 for a period of time sufficient to regenerate the catalyst. The hydrogen 150′ may also be flowed at a different temperature and/or pressure to remove the adhered hydrocarbon species. In addition, the flow of hydrogen 150 may be cycled from one direction to the other direction, by directionally cycling the output of the power source 330, to remove the dehydrogenated higher hydrocarbons 130 and higher hydrocarbons 140.

In addition to using the PERM 300 to transport the hydrogen 150 in both directions, the PERM 300 may also be used as a net producer of energy and/or hydrogen. The hydrogen 150 generated during the homologation reaction may be combusted to produce energy or the PERM 300 may be coupled with a fuel cell to produce power from the hydrogen 150. By using the hydrogen 150 to produce power, for example to provide power source 330, the homologation reaction may be energetically self-sustaining. The hydrogen 150 may also be recycled for use in other homologation reactions or chemical reactions.

The PERM 300 may also be used to enhance the extent of additional chemical reactions, such as chemical reactions that dehydrogenate alkanes. For example, the PERM 300 may be used to dehydrogenate ethane and/or propane to ethylene and/or propylene, respectively. By altering the catalytic material used in the catalyst layers 340, so that the catalyst layers 340 catalyze the desired reaction, ethane and/or propane may be dehydrogenated.

A method of producing a higher hydrocarbon 140 is also disclosed. The method comprises contacting the PERM 300 with the light alkane 100 to dehydrogenate the light alkane 100 to form the activated carbon species 120 and hydrogen 150. The hydrogen 150 is removed from the reaction side 310 of the PERM 300 to the hydrogen-rich side 320 by modulating the output of the power source 330 in a first manner. The activated carbon species 120 oligomerizes to form the dehydrogenated, higher hydrocarbon 130, which is rehydrogenated by flowing hydrogen 150′ from the hydrogen-rich side 320 of the PERM 300 to the reaction side 310.

To produce the higher hydrocarbon 140, the light alkane 100 may be chemisorbed onto the surface of the catalyst layer 340 on the reaction side 310 of the PERM 300. As used herein, the term “light alkane” 100 refers to a short hydrocarbon chain. The light alkane 100 may include, but is not limited to, methane, ethane, propane, butane, pentane, hexane, isomers thereof, and mixtures thereof. The light alkane 100 may optionally include non-reacting or inert species. A deposit of the activated carbon species 120 may be formed on the surface of the catalyst layer 340 by dehydrogenating the light alkane 100. In addition, the dehydrogenation reaction may produce hydrogen 150. Some of the hydrogen 150 on the reaction side 310 of the PERM 300 may be catalytically removed and transported to the hydrogen-rich side 320 when the power source 330 is activated. The activated carbon species 120 may then oligomerize to form the dehydrogenated higher hydrocarbon 130.

To rehydrogenate the dehydrogenated higher hydrocarbon 130 to form the higher hydrocarbon 140, hydrogen 150′ may be flowed from the hydrogen-rich side 320 of the PERM 300 to the reaction side 310 by modulating the output of the power source 330 in the reverse direction to that used to transport hydrogen 150 to the hydrogen-rich side 320. As used herein, the term “higher hydrocarbon” 140 refers to a hydrocarbon having between 6 and 12 carbon atoms. The higher hydrocarbon 140 may be a non-aromatic hydrocarbon including, but not limited to, hexane, heptane, octane, nonane, decane, undecane, dodecane, and mixtures thereof. In addition, derivatives or isomers of the higher hydrocarbon 140 may be formed, such as branched or cyclic hydrocarbons. The higher hydrocarbon 140 may also be an aromatic hydrocarbon having the same number of carbon atoms as the non-aromatic hydrocarbons (between 6 and 12 carbon atoms). The aromatic hydrocarbon may include, but is not limited to, benzene, toluene, xylene, and other alkyl benzene derivatives. The higher hydrocarbon may additionally include nonreacting or inert species. In one embodiment, the higher hydrocarbon 140 is a hydrocarbon having between 7 and 10 carbon atoms. The higher hydrocarbon 140 may be a liquid fuel that has a low vapor pressure. In one embodiment, the catalytic homologation reaction primarily produces low vapor pressure, higher hydrocarbons 140.

The homologation reaction may be conducted under moderate conditions, such as at a temperature of between approximately 200° C. and 400° C. While it is no longer necessary to conduct the two steps of the reaction at different temperatures, it is contemplated that different temperatures may still be used. The pressure of the homologation reaction may range from approximately atmospheric pressure to 500 psig. However, higher pressure may also be employed. Under these moderate conditions, the homologation reaction may produce yields and conversion efficiencies of up to approximately 100%.

The equilibrium of the two steps of the homologation reaction may be altered by modulating the power output. Since the presence of hydrogen 150 on the reaction side 310 of the PERM 300 limits the equilibrium of the dehydrogenation (the alkane conversion step), removing the hydrogen 150 from the reaction side 310 may reduce that constraint on the equilibrium. The hydrogen 150 may be transported from the reaction side 310 of the PERM 200 to the hydrogen-rich side 320 by activating the voltage and current provided by the power source 330. When the alkane conversion step is complete and the rehydrogenation step is to be performed, the hydrogen 150′ may be transported from the hydrogen-rich side 320 of the PERM 300 to the reaction side 310.

By controlling the flow of hydrogen 150, the equilibrium of the two steps of the homologation reaction is no longer limited. Since hydrogen 150 is transported from the reaction side 310 to the hydrogen-rich side 320, the alkane conversion step is not limited by the presence of hydrogen 150. Similarly, since hydrogen 150′ is transported from the hydrogen-rich side 320 to the reaction side 310, the rehydrogenation step is not limited by the amount of hydrogen 150 present on the reaction side 310. In addition, since the hydrogen 150′ used in the rehydrogenation step is obtained from the hydrogen-rich side 320 of the PERM 300, a separate source of hydrogen is no longer needed.

The method of the present invention may also be used to reactivate or clean the catalyst layer 340 on the reaction side 310 of the PERM 300. By flowing the hydrogen 150′ from the hydrogen-rich side 320 to the reaction side 310, dehydrogenated higher hydrocarbons 130 and/or higher hydrocarbons 140 that have adhered to the surface of this catalyst layer 340 may be removed. The hydrogen 150′ may be flowed in this direction for a sufficient amount of time to remove the adhered hydrocarbon species. The hydrogen 150′ may also be flowed at a different temperature and/or pressure than the temperature or pressure that is used during the homologation reaction. In addition, the flow of hydrogen 150 may be cycled from one direction to the other direction, by modulating the output of the power source 330, to remove the adhered species.

A PERM reactor to produce higher hydrocarbons from light alkanes 100 is also disclosed. The PERM reactor may be used to directly convert C₁-C₆ light alkanes or heavier alkanes to low vapor pressure, low sulfur gasoline and diesel fuels by using the equilibrium-shifting potential of the controllable PERM 300. By coupling the catalytic homologation reaction with the PEM 200, enhanced alkane dehydrogenation, hydrogen separation, and oligomerization may be obtained. The PERM reactor may be used in the petroleum refining industry, the chemical industry, or the natural gas industry to obtain higher yields of the higher hydrocarbons 140 and to improve the conversion efficiency of the light alkanes 100.

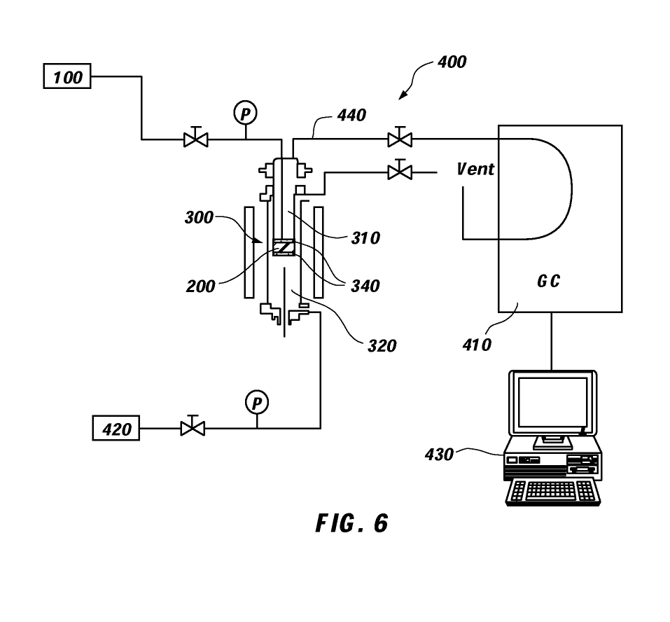

An exemplary PERM reactor is schematically shown in FIG. 6. The light alkane 100 may be flowed over the PERM 300, which includes the PEM 200, catalyst layers 340, and a power source 330 (not shown in FIG. 6 for clarity) operably coupled to the catalyst layers 340. The light alkane 100 may chemisorb to the catalyst layer 340 on the reaction side 310 of the PERM 300. The light alkane 100 may be converted to the activated carbon species 120, as previously described. The activated carbon species 120 is oligomerized and rehydrogenated to produce the higher hydrocarbon 140, as previously described. The PERM reactor 400 may also include means for detecting or analyzing the reactants and products of the reaction. For instance, an on-line gas chromatograph (“GC”) 410 connected to a computer 430 may be used to analyze the production of hydrogen 150 and the higher hydrocarbon 140 during the reaction. A sweep gas 420 may be provided on the back side of the PERM reactor 400 to remove the hydrogen 150, which is analyzed to determine the rate of hydrogen production. A reactor effluent stream 440 comprising the light alkane 100 and hydrogen 150 may be analyzed to determine alkane conversion, product yield, and selectivity for desired higher hydrocarbons.

The proton exchange reactive membrane reactor 400 is configured to produce the higher hydrocarbon 140 from the light alkane 100 without requiring a separate hydrogen source to rehydrogenate the dehydrogenated higher hydrocarbon 130. Unlike conventional reactors that require a separate hydrogen source, any hydrogen 150 that is used in the proton exchange reactive membrane reactor 400 to conduct the homologation reaction may be supplied from the hydrogen-rich side 320 of the PERM 300. For instance, the hydrogen 150 may be supplied by directionally and amplitudinally modulating the output of the power source 330 so that hydrogen 150′ is transported from the hydrogen-rich side 320 to the reaction side 310. In other words, the PERM 300 acts similar to an on/off valve for providing hydrogen 150 in the proton exchange reactive membrane reactor 400.

By sensing the current-voltage relationship within each half-cycle, detailed information about the reaction and transport performance of the proton exchange reactive membrane reactor 400 may be extracted. Both the shape of a current-voltage trace for a single cycle and changes in the trace over time may be useful. These parameters may be used to automatically adjust the operating conditions of the proton exchange reactive membrane reactor 400 and to inform operators about the performance of the proton exchange reactive membrane reactor 400, such as predicting a need for replacement of the PERM 300.

Thermodynamic analysis has shown that if excess hydrogen from the reaction is oxidized with oxygen to make water, either in situ (on the hydrogen-rich side 320 of the PERM 300) or external to the PERM reactor 400, the overall Gibbs free energy of the reaction is negative and the overall reaction sequence is exothermic. Therefore, high levels of conversion of light alkanes 100 to higher hydrocarbons 140 may be possible, the homologation reaction may be a net exporter of energy (or hydrogen), and the reaction may provide high conversion efficiencies of the light alkane 100.

Using the PERM 300 to enhance the equilibrium of the homologation reaction is advantageous in numerous respects. First, hydrogen 150 may be transported through the PERM 300 when it is needed, rather than switching the feed composition as is done in the reaction scheme of FIG. 1. Since it is faster to transport the hydrogen 150 as needed, rather than having to switch the gas sources and adjust the temperatures, the throughput of the reactor is also increased. Second, by using the PERM 300 to remove hydrogen 150 from the reaction side 310 of the PERM 300, the extent of the first step of the reaction is enhanced because the constraints on the equilibrium are reduced. Furthermore, by pumping hydrogen 150′ from the hydrogen-rich side 320 back across the PERM, the extent of the second step is enhanced. Third, the PERM 300 allows a catalyst cleaning step to be performed. By transporting hydrogen 150′ from the hydrogen-rich side 320 to the reaction side 310, higher hydrocarbons 140 and dehydrogenated higher hydrocarbons 130 that have absorbed to the surface of the catalyst are removed.

The value of upgrading a light alkane to a higher hydrocarbon that is useful as a liquid fuel is estimated to be in the range of $3-4 per barrel. In the U.S. refining system, these incentives may amount to several million dollars per year of benefit per refinery or several hundred million dollars per year in total, easily justifying the capital investment costs of implementing the present invention. As a further benefit, an additional use of light alkanes 100 (particularly C₂-C₄ light gases), which are normally not efficiently or economically used, may allow refinery planners to explore new options for refinery operating strategy by removing current constraints imposed by fuel gas balance or liquified propane gas (“LPG”) demand. Homologation of methane to liquid or easy-to-condense hydrocarbons may also have use in remote natural gas fields to allow easier transport of those hydrocarbons to market.

The present invention includes a controllable proton exchange reactive membrane that comprises a proton exchange membrane, at least two catalyst layers wherein at least one catalyst layer is disposed on each side of the membrane, and a power source operably coupled to at least one of the catalyst layers on each side of the membrane. A direction and magnitude of hydrogen flow across the proton exchange reactive membrane is controlled by modulating an output of the power source. In addition, a method of producing a higher hydrocarbon from a light alkane is also disclosed, as is a method of reactivating the catalyst layer.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method of producing a higher hydrocarbon from a light alkane, comprising:
contacting at least one catalyst of a proton exchange reactive membrane with the light alkane to dehydrogenate
the light alkane to produce an activated carbon species and hydrogen; and
transporting hydrogen across the proton exchange reactive membrane by modulation of an output of a power source operably coupled to the proton exchange reactive membrane to enhance an extent of a reaction to produce the higher hydrocarbon.

2. The method of claim 1, wherein contacting at least one catalyst of a proton exchange reactive membrane with the light alkane comprises contacting at least one catalyst of a proton exchange reactive membrane with a light alkane selected from the group consisting of methane, ethane, propane, butane, pentane, hexane, isomers thereof, and mixtures thereof.

3. The method of claim 1, wherein transporting hydrogen across the proton exchange reactive membrane by modulation of an output of a power source to enhance an extent of a reaction to produce the higher hydrocarbon comprises transporting hydrogen from a first side of the proton exchange reactive membrane to a second side of the proton exchange reactive membrane.

4. The method of claim 3, wherein transporting hydrogen across the proton exchange reactive membrane by modulation of an output of a power source to enhance an extent of a reaction to produce the higher hydrocarbon comprises transporting hydrogen to enhance the extent of converting the light alkane to the activated carbon species.

5. The method of claim 1, wherein transporting hydrogen across the proton exchange reactive membrane by modulation of an output of a power source to enhance an extent of a reaction to produce the higher hydrocarbon comprises oligomerizing the activated carbon species to form a dehydrogenated, higher hydrocarbon.

6. The method of claim 1, wherein transporting hydrogen across the proton exchange reactive membrane by modulation of an output of a power source to enhance an extent of a reaction to produce the higher hydrocarbon comprises transporting hydrogen from a second side of the proton exchange reactive membrane to a first side of the proton exchange reactive membrane.

7. A method of producing a higher hydrocarbon from a light alkane, comprising:
contacting the light alkane with a catalyst layer on a first side of a proton exchange reactive membrane to dehydrogenate the light alkane and produce an activated carbon species and hydrogen;
transporting hydrogen from the first side of the proton exchange reactive membrane to a second side thereof by modulating in a first manner an output of a power source operably coupled to the catalyst layer;
oligomerizing the activated carbon species on the first side of the proton exchange reactive membrane to form a dehydrogenated, higher hydrocarbon; and
hydrogenating the dehydrogenated, higher hydrocarbon to produce a higher hydrocarbon.

8. The method of claim 7, wherein transporting hydrogen from the first side of the proton exchange reactive membrane to the second side thereof comprises transporting hydrogen from a reaction side to a hydrogen-rich side of the proton exchange reactive membrane.

9. The method of claim 7, wherein transporting hydrogen from the first side of the proton exchange reactive membrane to the second side thereof comprises transporting hydrogen at a sufficient rate to render the rate of dehydrogenation of the light alkane substantially similar to the rate of hydrogenating the dehydrogenated, higher hydrocarbon.

10. The method of claim 7, further comprising modulating the output of the power source in a second manner to transport hydrogen from the second side of the proton exchange reactive membrane to the first side thereof.

11. The method of claim 10, wherein modulating an output of the power source in the second manner comprises transporting hydrogen to enhance an extent of hydrogenating the dehydrogenated, higher hydrocarbon to produce the higher hydrocarbon.

12. The method of claim 7, further comprising reactivating the catalyst layer by flowing hydrogen from the second side of the proton exchange reactive membrane to the first side thereof.

13. A method of reactivating a catalyst layer, comprising:
directionally modulating an output of the power source operably coupled to at least two catalyst layers disposed on opposing sides of a proton exchange reactive membrane to cause hydrogen to flow from a hydrogen-rich side of the proton exchange reactive membrane to a reaction side thereof; and
flowing the hydrogen from the hydrogen-rich side of a proton exchange reactive membrane to a reaction side of the proton exchange reactive membrane to remove at least one hydrocarbon species adhered to a surface of the catalyst layer on the reaction side.

14. The method of claim 13, wherein flowing the hydrogen from the hydrogen-rich side of the proton exchange reactive membrane to the reaction side of the proton exchange reactive membrane comprises flowing the hydrogen for a sufficient amount of time to remove the at least one adhered hydrocarbon species.

15. The method of claim 13, wherein flowing the hydrogen from the hydrogen-rich side of the proton exchange reactive membrane to the reaction side of the proton exchange reactive membrane comprises flowing the hydrogen at a temperature or pressure sufficient to remove the at least one adhered hydrocarbon species.

16. The method of claim 13, wherein flowing the hydrogen from the hydrogen-rich side of the proton exchange reactive membrane to the reaction side of the proton exchange reactive membrane comprises bidirectionally cycling the hydrogen across the proton exchange reactive membrane to remove the at least one adhered hydrocarbon species.

17. A method of producing a higher hydrocarbon from a light alkane, comprising:
dehydrogenating the light alkane on a first side of the proton exchange reactive membrane to produce an activated carbon species and hydrogen;
transporting hydrogen from the first side of the proton exchange reactive membrane to a second side thereof;
oligomerizing the activated carbon species on the first side of the proton exchange reactive membrane to form a dehydrogenated, higher hydrocarbon; and
hydrogenating the dehydrogenated, higher hydrocarbon to produce the higher hydrocarbon.

18. A method of dehydrogenating an alkane, comprising:
contacting the alkane with at least one of at least two catalyst layers on a proton exchange reactive membrane to dehydrogenate the alkane to form an alkene; and
transporting hydrogen across the proton exchange reactive membrane by modulation of an output of a power source operably connected to the at least two catalyst layers to increase a throughput of a homologation reaction to produce the alkene.

19. The method of claim 18, wherein contacting the alkane with at least one of at least two catalyst layers on a proton exchange reactive membrane comprises contacting at least one of propane, ethane, or mixtures thereof with at least one of the at least two catalyst layers on the proton exchange reactive membrane.

20. The method of claim 18, wherein contacting the alkane with at least one of at least two catalyst layers on a proton exchange reactive membrane comprises accumulating hydrogen to limit the equilibrium of dehydrogenating the alkane.

21. The method of claim 18, further comprising reactivating the at least one of the at least two catalyst layers by flowing hydrogen from a hydrogen-rich side of the proton exchange reactive membrane to a reaction side of the proton exchange reactive membrane.

22. (canceled)

23. (canceled)

24. (canceled)

25. The method of claim 1, wherein transporting hydrogen across the proton exchange reactive membrane by modulation of an output of a power source to enhance an extent of a reaction to produce the higher hydrocarbon comprises transporting hydrogen to produce a higher hydrocarbon selected from the group comprising ethylene and propylene.

26. The method of claim 17, further comprising transporting hydrogen from the second side of the proton exchange reactive membrane to the first side thereof.

27. The method of claim 17, wherein transporting hydrogen from the first side of the proton exchange reactive membrane to the second side thereof comprises transporting hydrogen from a reaction side to a hydrogen-rich side of the proton exchange reactive membrane.

28. The method of claim 17, wherein oligomerizing the activated carbon species on the first side of the proton exchange reactive membrane comprises modulating a power source operably coupled to the first side of the proton exchange reactive membrane.
